(19) United States
(12) Patent Application Publication
(10) Pub. No.: US 2026/0019700 A1
(43) Pub. Date: Jan. 15, 2026

(54) LENS SYSTEM AND PROGRAM

(71) Applicant: Tamron Co., Ltd., Saitama (JP)

(72) Inventor: Tomoharu SAITO, Saitama (JP)

(73) Assignee: Tamron Co., Ltd., Saitama (JP)

(21) Appl. No.: 19/227,536

(22) Filed: Jun. 4, 2025

(30) Foreign Application Priority Data
Jul. 11, 2024 (JP) 2024-111627

(51) Int. Cl. H04N 23/62; H04N 23/55; H04N 23/63

(52) U.S. Cl. CPC H04N 23/62; H04N 23/55; H04N 23/631

(57) ABSTRACT

A lens system includes: a lens optical system; at least one operation member that receives at least an actuation operation that is an operation for changing a state of the lens optical system; at least one memory; and at least one processor, in which the at least one processor controls the lens optical system such that operation sensitivity that is a ratio of an amount of change in the state of the lens optical system to an operation amount of the actuation operation input to the at least one operation member changes according to a difference between a storage state that is a state of the lens optical system and is stored in the at least one memory in advance and a current state that is a current state of the lens optical system.

### CROSS-REFERENCE TO RELATED APPLICATIONS

This application is based on and claims the benefit of priority from Japanese Patent Application No. 2024-111627, filed on Jul. 11, 2024, the entire contents of which are incorporated herein by reference.

### BACKGROUND OF THE INVENTION

### Technical Field

The present invention relates to a lens system and a program.

### Related Art

With the spread of video posting sites such as

TikTok (registered trademark) and YouTube (registered trademark), there is an increasing need for a video capturing technology using a camera, such as a mirrorless single lens camera, and a technology for controlling a lens mounted on the camera.

As the technique for controlling a lens, for example, JP 2023-175426 A describes a lens system that controls a portion of a virtual screen displayed on a touch display in accordance with a scroll operation by a user, and controls a lens optical system such that a state of the lens optical system is coordinated with the portion of the virtual screen displayed on the touch display. In addition, JP 2023-175426 A describes a technique of limiting a portion of the virtual screen that can be displayed on the touch display to a part of the virtual screen based on information indicating a position of a limit end set by a user, and thereby controlling the lens optical system so as to coordinate with a portion displayed on the touch display. According to such a technique, for example, when a focus position is manually operated as the state of the lens optical system, the lens optical system can be reliably stopped at a position corresponding to the limit end. Therefore, it is possible to reliably set an in-focus position that is desired by the user and corresponds to the stopped focus position.

In the technique described in JP 2023-175426 A, for example, when the focus is operated as the state of the lens optical system, a change in the focus suddenly stops when the focus reaches the position corresponding to the limit end, and thus a change in the focus of a moving image to be captured also suddenly stops. Therefore, the captured moving image may lack emotion to be felt by a viewer or may put a burden on the viewer's eyes.

Therefore, there is a demand for alleviating the sudden stop of the change when the state of the lens optical system is changed, for example, from the viewpoint of implementing emotional rack focusing.

An object of one aspect of the present invention is to implement a technology that enables a smooth change in a state of a lens optical system.

### SUMMARY OF THE INVENTION

In order to solve the above problems, a lens system according to one aspect of the present invention includes a lens optical system, at least one operation member that receives at least an actuation operation that is an operation for changing a state of the lens optical system, at least one memory, and at least one processor. The at least one processor controls the lens optical system such that operation sensitivity that is a ratio of an amount of change in the state of the lens optical system to an operation amount of the actuation operation input to the at least one operation member changes according to a difference between a storage state that is a state of the lens optical system and is stored in the at least one memory in advance and a current state that is a current state of the lens optical system.

Furthermore, a program according to one aspect of the present invention is a program for controlling a lens system including: a lens optical system; at least one operation member that receives at least an actuation operation that is an operation for changing a state of the lens optical system; at least one memory; and at least one processor, the program causing the at least one processor to execute processing of controlling the lens optical system such that operation sensitivity that is a ratio of an amount of change in the state of the lens optical system to an operation amount of the actuation operation input to the at least one operation member changes according to a difference between a storage state that is a state of the lens optical system and is stored in the at least one memory in advance and a current state that is a current state of the lens optical system.

According to one aspect of the present invention, it is possible to implement a technique capable of smoothly changing a state of the lens optical system.

### BRIEF DESCRIPTION OF THE DRAWINGS

FIG. 1 is a block diagram illustrating a configuration of a lens system according to a first embodiment of the present invention;

FIGS. 2A and 2B are schematic diagrams illustrating an outline of control processing of the lens system illustrated in FIG. 1, FIG. 2A illustrates a configuration of a display and a virtual screen by an operation terminal, and FIG. 2B illustrates a configuration of a focus of the lens optical system;

FIG. 3 is a flowchart illustrating a procedure of processing executed by a processor of an operation terminal illustrated in FIG. 1 to control the lens optical system;

FIGS. 4A and 4B are schematic diagrams for explaining sensitivity determination processing executed by the operation terminal illustrated in FIG. 1, FIG. 4A illustrates a configuration of the display and the virtual screen by the operation terminal, and FIG. 4B illustrates a correspondence relationship between a difference and operation sensitivity;

FIGS. 5A to 5C are schematic diagrams illustrating screen scroll amount calculation processing executed by the operation terminal illustrated in FIG. 1, FIG. 5A illustrates a direction of an input scroll operation and a direction of screen scroll coordinated with the scroll operation, FIG. 5B illustrates a screen scroll amount calculated based on the scroll operation, and FIG. 5C illustrates a relationship between an integrated operation amount and the focus;

FIGS. 6A and 6B are schematic diagrams illustrating magnification determination processing executed by the operation terminal illustrated in FIG. 1, FIG. 6A illustrates the display by the operation terminal, and FIG. 6B illustrates a correspondence relationship between the operation sensitivity and a magnification;

FIG. 7 is a flowchart illustrating a procedure of control processing executed by a processor of a lens illustrated in FIG. 1;

FIG. 8 is a flowchart illustrating a procedure of processing executed by the processor of the operation terminal illustrated in FIG. 1 to store a storage state to a memory;

FIGS. 9A and 9B are schematic diagrams illustrating restoration processing executed by the processor of the operation terminal and the processor of the lens illustrated in FIG. 1, FIG. 9A illustrates a change in the display by the operation terminal in the restoration processing, and FIG. 9B illustrates a correspondence relationship between a difference and a change speed in the restoration processing; and

FIG. 10 illustrates a modification example of the correspondence relationship between the difference and the operation sensitivity illustrated in FIG. 4B.

### DESCRIPTION OF THE EMBODIMENTS

### First Embodiment

Hereinafter, a first embodiment, which is an embodiment of the present invention, will be described in detail.

### (Lens System 100)

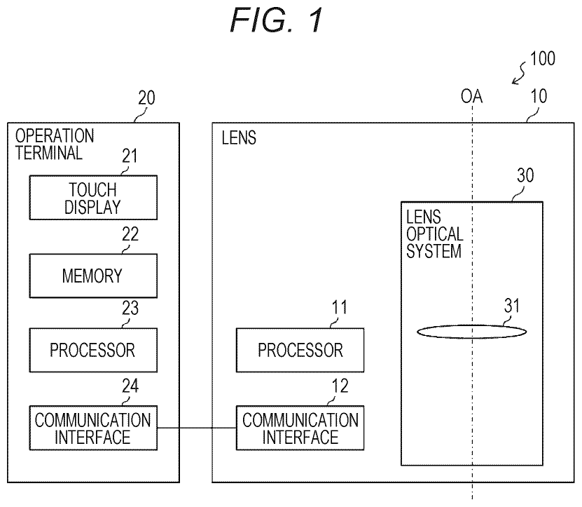

A configuration of a lens system 100 according to the first embodiment of the present invention will be described with reference to FIG. 1. FIG. 1 is a block diagram illustrating the configuration of the lens system 100 according to the first embodiment of the present invention. The lens system 100 is a system for controlling a lens optical system to suitably obtain an image of a subject in at least one of still image capturing and moving image capturing. In the present specification, the “lens optical system” refers to a lens unit including at least one single lens and a support member that supports the at least one single lens.

As illustrated in FIG. 1, the lens system 100 includes a lens 10 and an operation terminal 20. The lens 10 and the operation terminal 20 are communicably connected to each other via communication means. In the present embodiment, the lens 10 and the operation terminal 20 are connected by a universal serial bus (USB) cable via a communication interface 12 included in the lens 10 and a communication interface 24 included in the operation terminal 20.

In the present embodiment, the USB cable is used as the communication means for connecting the lens 10 and the operation terminal 20, but the present invention is not limited thereto. The communication means connecting the lens 10 and the operation terminal 20 may be any means capable of mediating transmission and reception of electronic data between the lens 10 and the operation terminal 20, and may be either wired communication means or wireless communication means. Specific examples of the wireless communication means include Wi-Fi (registered trademark) communication, near field communication (NFC), and Bluetooth (registered trademark) communication. In addition, the communication means may directly connect the lens 10 and the operation terminal 20 or may indirectly connect the lens 10 and the operation terminal 20. Examples of a network that can be interposed between the lens 10 and the operation terminal 20 include a local area network (LAN) and mount communication of a camera. In an embodiment in which the mount communication of the camera is used, for example, the lens 10 is mounted on a mount of the camera, and the operation terminal 20 is communicably connected to the camera, whereby the mount communication is implemented.

### (Operation Terminal 20)

The operation terminal 20 is configured to allow a user to input an operation as an instruction to the lens system 100 and to display a state of the lens optical system to the user. In the present embodiment, a smartphone is used as the operation terminal 20. As illustrated in FIG. 1, the operation terminal 20 is separated from the lens 10 and includes a touch display 21, a memory 22, a processor 23, and the communication interface 24.

The touch display 21 functions as an operation member to which the user inputs an operation, and also functions as a display member that displays information regarding control of the lens optical system 30 to the user. In the present embodiment, the touch display 21 is an electronic component in which a touch sensor that detects a touch operation input by the user and a display that displays the state of the lens optical system 30 to the user are integrally combined. As a conversion method in the touch sensor, a known method such as a resistive film method, a capacitance method, a surface acoustic wave method, an infrared method, an electromagnetic induction method, an image recognition method, and an optical sensor method can be appropriately adopted. As the display, a known display such as a liquid crystal display or an organic electroluminescence (EL) display can be used.

The touch display 21 has a display region. The display region is at least a part of the display of the touch display 21, and is a region for displaying a part of a virtual screen as a physical screen region. In the present specification, the “virtual screen” refers to a graphic that the processor 23 generates on a virtual space by electronic calculation. In addition, the “physical screen region” refers to a portion of the virtual screen displayed in the display region of the touch display 21. The configurations of the display region and the virtual screen will be described later with reference to a different drawing. As the display region and the virtual screen according to the present embodiment, the configuration described in JP 2023-175426 A may be employed to the extent that it does not contradict the configuration according to the present embodiment described later.

The memory 22 is configured to store a storage state and a threshold value. In the present embodiment, the memory 22 includes a primary memory and a secondary memory. The primary memory has a function of volatilely storing the storage state and the threshold value. The secondary memory has a function of storing a control processing program P20 in a nonvolatile manner. In the present embodiment, a dynamic random-access memory (DRAM) is used as the primary memory, and a flash memory is used as the secondary memory. Note that the storage state and the threshold value stored in the primary memory may be stored in a nonvolatile memory such as an electrically erasable programmable read-only memory (EEPROM, registered trademark) when the memory 22 is powered off, and may be restored from the EEPROM to the primary memory when the memory 22 is powered on, so as to be maintained even when the memory 22 is powered off.

The processor 23 is configured to control the overall operation of the operation terminal 20. The processor 23 is, for example, a central processing unit (CPU), a graphics processing unit (GPU), or a combination thereof. The processor 23 mainly executes control processing S20 and S30 of the operation terminal 20 by developing and executing the control processing program P20 stored in the memory 22 of the operation terminal 20. The control processing S20 and S30 executed by the processor 23 will be described later with reference to different drawings.

The communication interface 24 is configured to control transmission of various data from the operation terminal 20 and reception of various data by the operation terminal 20. In the present embodiment, a USB interface is used as the communication interface 24.

### (Lens 10)

The lens 10 may have a configuration for forming an image of the subject on an image sensor provided in the camera. In the present embodiment, a lens detachably attached to the camera is used as the lens 10. As illustrated in FIG. 1, the lens 10 includes a processor 11, the communication interface 12, and the lens optical system 30.

The processor 11 is a configuration for controlling the overall operation of the lens 10. The processor 11 develops and executes a control processing program P10 stored in a memory of the lens 10, receives a command signal from the processor 23 of the operation terminal 20, and mainly executes control processing S10 of the lens 10. In the present embodiment, a CPU is used as the processor 11. The control processing S10 executed by the processor 11 will be described below with reference to a different drawing.

The communication interface 12 is a configuration for controlling transmission of various data from the lens 10 and reception of various data by the lens 10. In the present embodiment, a USB interface is used as the communication interface 12.

The lens optical system 30 is an optical element group arranged on an optical axis OA passing through the subject. As illustrated in FIG. 1, the lens optical system 30 includes a focus group 31 as an optical element.

The focus group 31 is an optical element for changing an in-focus position of the entire lens optical system 30 included in the lens 10. The focus group 31 changes a focus position in order to change the in-focus position. Here, the focus position means a position of at least one single lens included in the focus group 31 inside the lens optical system 30, and is distinguished from the in-focus position that is a position at which the subject is in focus on the optical axis OA. Hereinafter, in the present specification, the “focus position of the entire lens optical system 30 included in the lens 10” may be referred to as “focus of the lens optical system 30” or simply as “focus”. In the present embodiment, the focus is controlled by driving the single lens of the focus group 31 along the optical axis OA. In the present specification, “controlling the lens optical system 30” includes changing or maintaining any one or more of states of the lens optical system 30.

### (Control Processing S100 of Lens System 100)

Control processing S100 of the lens system 100 will be described below. The control processing S100 is processing of controlling the lens optical system 30 such that operation sensitivity that is a ratio of an amount of change in the state of the lens optical system 30 to an operation amount of an operation input to the touch display 21 changes according to a difference between the storage state that is a state of the lens optical system 30 and is stored in the memory 22 in advance and a current state that is a current state of the lens optical system 30. In the present embodiment, the focus is controlled as the state of the lens optical system 30.

In the present embodiment, the control processing S100 includes the control processing S10 of the lens 10 and the control processing S30 of the operation terminal 20 for controlling the focus. The control processing S100 is executed by the processor 23 of the operation terminal 20 executing the control processing S30 with reference to the storage state, and the processor 11 of the lens 10 executing the control processing S10 in coordination with the control processing S30. The control processing S100 further includes the control processing S20 of the operation terminal 20 for storing the storage state in the memory 22.

### (Outline of Control Processing S100)

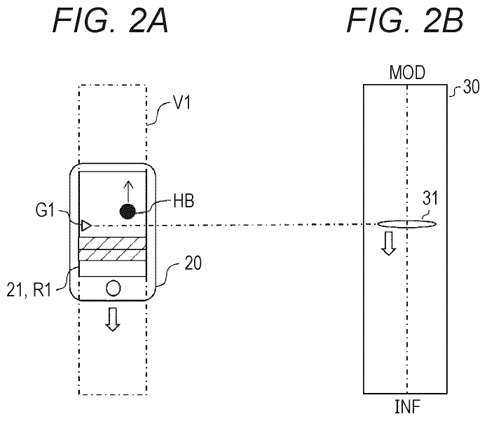

Before detailed description of the processing included in the control processing S100, an outline of the control processing S100 will be described with reference to FIGS. 2A and 2B. FIGS. 2A and 2B are schematic diagrams illustrating the outline of the control processing S100 of the lens system 100 illustrated in FIG. 1, FIG. 2A illustrates a configuration of a display and a virtual screen V1 by the operation terminal 20, and FIG. 2B illustrates a configuration of the focus of the lens optical system 30.

As illustrated in FIG. 2A, the touch display 21 of the operation terminal 20 has a display region R1 that spreads over the entire display of the touch display 21. A portion of the virtual screen V1 is displayed in the display region R1. The virtual screen V1 is a rectangular graphic having the same width (horizontal direction) as that of the display region R1 and having a length (vertical direction) larger than the that of the display region R1. In the display region R1, a pointer G1 is further displayed at a fixed position independent of the virtual screen V1. The pointer G1 indicates the current state to be described later.

In the control processing S30 of the operation terminal 20, when a touch position HB of the user slides, that is, when a scroll operation is input to the touch display 21, a portion of the virtual screen V1 displayed in the display region R1 is scrolled such that the graphic substantially follows the touch position HB. As an example, when the touch position HB slides upward, the portion of the virtual screen displayed in the display region R1 is scrolled downward. In the present embodiment, the scrolling of the portion of the virtual screen V1 displayed in the display region R1 is referred to as “scrolling of the screen” or the like.

In FIG. 2B, an upper end of an axis passing through the focus group 31 of the lens optical system 30 represents a near end (MOD) of the focus, and a lower end of the axis represents an infinity end (INF) of the focus. The virtual screen V1 illustrated in FIG. 2A corresponds to the axis illustrated in FIG. 2B, and the pointer G1 illustrated in FIG. 2A corresponds to the current position of the focus illustrated in FIG. 2B. As an example, as the screen is scrolled downward in the control processing S30 of the operation terminal 20, the lens optical system 30 is controlled such that the focus moves further in the INF direction in the control processing S10 of the lens 10 in coordination with the scrolling. As an example, when the pointer G1 is superimposed on the lower end of the virtual screen V1, the lens optical system 30 is controlled so that the focus is on the INF.

### (Control Processing S30 of Operation Terminal 20)

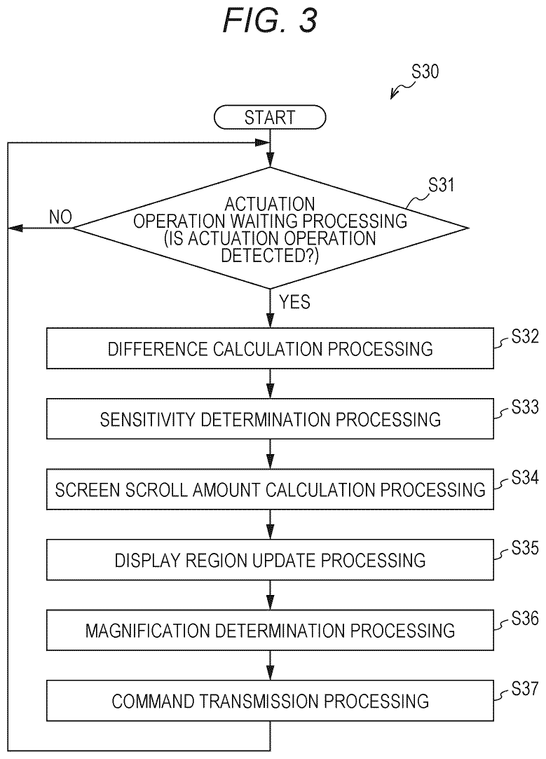

The control processing S30 of the operation terminal 20 will be described with reference to FIG. 3. FIG. 3 is a flowchart illustrating a procedure of the processing S30 executed by the processor 23 of the operation terminal 20 illustrated in FIG. 1 to control the lens optical system 30. The control processing S30 is processing for controlling the focus according to an operation input to the touch display 21 to change the state of lens optical system 30. As illustrated in FIG. 3, the control processing S30 includes actuation operation waiting processing S31, difference calculation processing S32, sensitivity determination processing S33, screen scroll amount calculation processing S34, display region update processing S35, magnification determination processing S36, and command transmission processing S37. In the present embodiment, the above-described processing is mainly executed by the processor 23 of the operation terminal 20.

### (Actuation Operation Waiting Processing S31)

The actuation operation waiting processing S31 is processing in which the processor 23 waits for an operation (actuation operation) for changing the state of the lens optical system 30 on the touch display 21 by the user. While the touch sensor of the touch display 21 does not detect the actuation operation by the user (“NO”), the processor 23 loops the actuation operation waiting processing S31. When the touch sensor of the touch display 21 receives the actuation operation (“YES”), the touch sensor transmits, to the processor 23, a signal notifying the operation amount and the operation direction of the actuation operation, and the processor 23 having received the signal starts the subsequent difference calculation processing S32. In the present embodiment, a scroll operation in the vertical direction input in the display region R1 of the touch display 21 is adopted as the actuation operation.

### (Difference Calculation Processing S32)

The difference calculation processing S32 is processing in which the processor 23 calculates a difference between the storage state and the current state.

The storage state is information regarding at least one predetermined focus state as the state of the lens optical system 30, that is, the focus position. In the present embodiment, the storage state is information representing at least one predetermined coordinate on a coordinate axis extending in the vertical direction of the virtual screen V1, and the information can be transformed into information representing at least one predetermined focus according to a transform formula defined in the control processing program P10 or P20. Note that the present invention is not limited thereto, and the storage state may be information itself representing at least one predetermined focus. Alternatively, the storage state may be any information that can be transformed into information indicating at least one predetermined focus. The storage state is stored in the memory 22 in advance.

The current state is information regarding the current state of the focus as the state of the lens optical system 30, that is, the current focus position. In the present embodiment, the current information is information representing coordinates of the pointer G1 on the coordinate axis extending in the vertical direction of the virtual screen V1, and the current information can be transformed into information representing one focus according to a transform formula defined in the control processing program P10 or P20. Note that the present invention is not limited thereto, and the current state may be information representing at least one predetermined focus itself. Alternatively, the current state may be any information that can be transformed into at least one predetermined focus.

Regarding the current state, the processor 23 may generate the current state by referring to a signal that notifies the current state of the focus detected by a sensor of the lens optical system 30 and has been received by the processor 23 from the sensor. In this case, based on the generated current information, the processor 23 determines a portion of the virtual screen V1 to be displayed in the display region R1 such that the coordinates of the pointer G1 on the coordinate axis extending in the vertical direction of the virtual screen V1 match the current state.

In the present embodiment, the processor 23 calculates an absolute value of a difference between coordinates represented by the storage state and coordinates represented by the current state on the coordinate axis extending in the vertical direction of the virtual screen V1 as the difference between the storage state and the current state. However, the processor 23 may calculate, as the difference between the coordinates, a difference having a positive or negative value along the upward direction or the downward direction of the coordinate axis. Furthermore, in a case where the storage state and the current state represent the focus itself, the processor 23 may calculate a difference between the focus represented by the storage state and the focus represented by the current state as the difference between the storage state and the current state. In a case where one of the storage state and the current state represents coordinates and the other represents the focus, the processor 23 may transform the one of the storage state and the current state representing the coordinates into information representing the focus and calculate a difference between the transformed one focus and the other focus. The processor 23 may perform the inverse transform and calculate the difference.

### (Sensitivity Determination Processing S33)

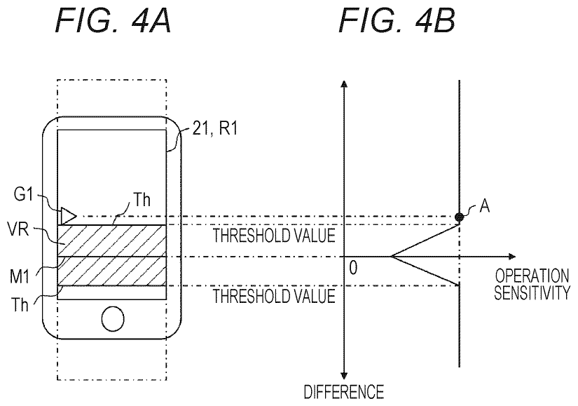

The sensitivity determination processing S33 is processing in which the processor 23 determines the operation sensitivity with reference to the difference calculated in the difference calculation processing S32. In the present embodiment, the operation sensitivity refers to the ratio of the amount of change in the focus to a distance by which the touch position in the scroll operation input to the touch display 21 slides, that is, a scroll operation amount. The sensitivity determination processing S33 will be described with reference to FIGS. 4A and 4B. FIGS. 4A and 4B are schematic diagrams for explaining the sensitivity determination processing S33 executed by the operation terminal 20 illustrated in FIG. 1, FIG. 4A illustrates a configuration of the display and the virtual screen V1 by the operation terminal 20, and FIG. 4B illustrates a correspondence relationship between the difference and the operation sensitivity.

As illustrated in FIG. 4A, the display region R1 of the touch display 21 displays the storage state as a marker M1 representing coordinates. The display region R1 displays the current state as the pointer G1 representing the coordinates. In the display region R1, a region including the marker M1 is displayed as a variable region VR on the coordinate axis extending in the vertical direction of the virtual screen V1, and two threshold values are displayed as two (upper end and lower end) end portions Th of the variable region VR. The display enables the user to easily recognize the storage state and the current state, and further improves the operability of the lens system 100 for the user. Furthermore, in the present embodiment, the touch display 21 functions as a display member as described above, and also exhibits a function of receiving a scroll operation as the actuation operation. Therefore, the operability of the lens system 100 for the user is further improved. The marker M1, the two end portions Th, and the variable region VR are components of the virtual screen V1. The two threshold values are stored in the memory 22 in advance, and a region sandwiched between the two end portions Th is displayed as the variable region VR. In addition, in the present invention, the display region R1 is not limited to the configuration illustrated in FIG. 4A, and for example, only either the marker M1 or the two end portions Th may be displayed.

FIG. 4B illustrates a correspondence relationship between the difference between the storage state and the current state and the operation sensitivity according to the present embodiment, and the correspondence relationship is stored in the memory 22 of the operation terminal 20 in advance. Hereinafter, the correspondence relationship between the difference and the operation sensitivity may be referred to as a “sensitivity profile”. As illustrated in FIG. 4B, the operation sensitivity changes according to the difference. Since the operation sensitivity changes according to the difference, the operation sensitivity with respect to the difference in a specific range becomes smaller than the operation sensitivity with respect to the difference in the other ranges. Therefore, even if the user continues to input a scroll operation at a constant speed, the change speed of the focus decreases in the specific range where the operation sensitivity decreases. Therefore, it is possible to smoothly control the focus even with a scroll operation at a constant speed.

In the present embodiment, the operation sensitivity is constant when the difference is equal to or greater than the threshold value. When the difference is less than the threshold value, the operation sensitivity is lower than when the difference is equal to or greater than the threshold value. This makes it possible to smoothly control the focus within a range where the difference is less than the threshold value. When the difference is less than the threshold value, the smaller the difference, the lower the operation sensitivity. As a result, as the difference decreases, that is, as the current state approaches the storage state, the change speed of the focus decreases. Therefore, even when the scroll operation is performed at a constant speed, the focus can be more smoothly controlled in a state close to the storage state. The sensitivity profile is axisymmetric with respect to the axis of the operation sensitivity, and the operation sensitivity is uniquely determined according to the absolute value of the difference.

The sensitivity profile is associated with the display and the virtual screen by the operation terminal illustrated in FIG. 4A. As a specific example, when the marker M1 indicating the storage state matches the pointer G1 indicating the current state in the display illustrated in FIG. 4A, the marker M1 corresponds to the difference that is 0 in the sensitivity profile illustrated in FIG. 4B.

In the sensitivity determination processing S33, the processor 23 refers to the calculated difference and the sensitivity profile, and determines the operation sensitivity as an objective variable by introducing the difference to the sensitivity profile as an explanatory variable. As an example, in FIGS. 4A and 4B, the processor 23 determines the operation sensitivity as sensitivity corresponding to a point A.

### (Screen Scroll Amount Calculation Processing S34)

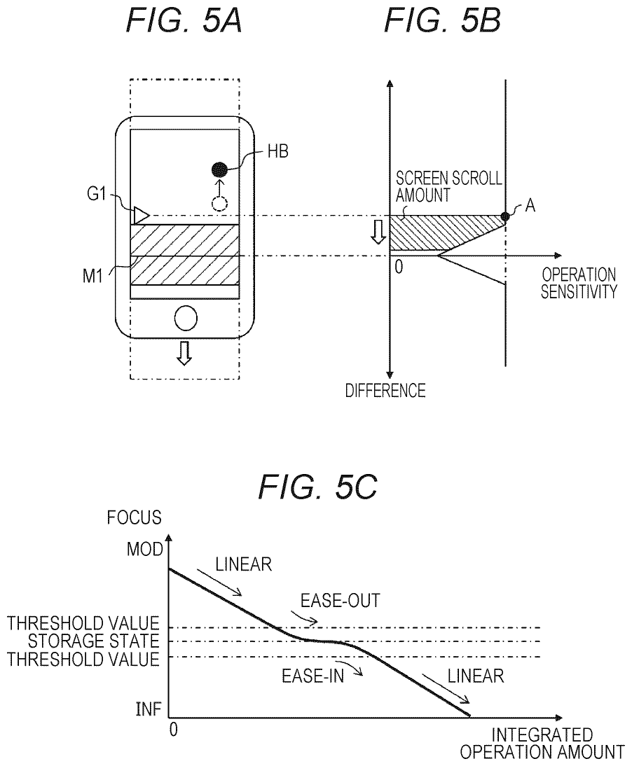

The screen scroll amount calculation processing S34 is processing in which the processor 23 calculates the screen scroll amount and the screen scroll direction with reference to the operation amount and the operation direction of the actuation operation (scroll operation) notified in the actuation operation waiting processing S31 and the sensitivity determined in the sensitivity determination processing S33. In the present embodiment, the screen scroll amount and the screen scroll direction respectively refer to the scroll amount and the scroll direction during scrolling of the screen in the display region update processing S35 to be described later. The screen scroll amount calculation processing S34 will be described with reference to FIGS. 5A to 5C. FIGS. 5A to 5C are schematic diagrams illustrating the screen scroll amount calculation processing S34 executed by the operation terminal 20 illustrated in FIG. 1, FIG. 5A illustrates a direction of an input scroll operation and a direction of screen scroll coordinated with the scroll operation, FIG. 5B illustrates a screen scroll amount calculated based on the scroll operation, and FIG. 5C illustrates a relationship between an integrated operation amount and the focus.

The processor 23 determines the screen scroll direction to be a direction opposite to the operation direction of the scroll operation. In addition, the processor 23 calculates the screen scroll amount by multiplying the determined operation sensitivity by the operation amount and the operation direction of the scroll operation. As an example, as illustrated in FIG. 5A, a case where the touch position HB slides in a direction from the marker M1 toward the pointer G1, that is, a scroll operation is input will be described. In this case, the processor 23 determines the screen scroll direction to be the direction opposite to the operation direction of the scroll operation, that is, the direction from the pointer G1 toward the marker M1, in other words, the direction in which the difference approaches 0. As illustrated in FIG. 5B, the processor 23 performs integration along the sensitivity profile in the direction in which the screen scrolls (the direction in which the difference approaches 0) starting from the determined operation sensitivity (point A) by an amount corresponding to the operation amount of the scroll operation, and calculates the integrated amount as the screen scroll amount.

As will be understood from the following description, the screen scroll amount is proportional to the amount of change in the focus. Therefore, as illustrated in FIG. 5C, the relationship (easing curve) between the focus and the integrated operation amount of the scroll operation obtained from the sensitivity profile illustrated in FIG. 4B has four stages, which are two linear stages, an ease-out stage, and an ease-in stage. An operation in each stage when the scroll operation is continuously input at a constant speed will be described below. In the two linear stages, the change speed of the focus is also constant, and the focus operates to follow the operation. In the ease-out stage, the change speed of the focus gradually decreases, and thus the change speed is lowest in a state close to the storage state. In the ease-in stage, the change speed of the focus gradually increases, and thus the focus smoothly moves away from the storage state.

### (Display Region Update Processing S35)

The display region update processing S35 is processing in which the processor 23 updates the graphic displayed in the display region R1 with reference to the screen scroll amount and the screen scroll direction calculated in the screen scroll amount calculation processing S34. The processor 23 updates the graphic such that the portion of the virtual screen V1 displayed in the display region R1 is scrolled in the calculated screen scroll direction by the calculated screen scroll amount. As a result, the display region R1 of the touch display 21 displays an image scrolled in coordination with the scroll operation amount and the scroll operation direction of the scroll operation input to touch display 21. The coordinated display of the image enables the user to operate the lens system 100 more intuitively and more easily, and the operability of the lens system 100 for the user is further improved.

### (Magnification Determination Processing S36)

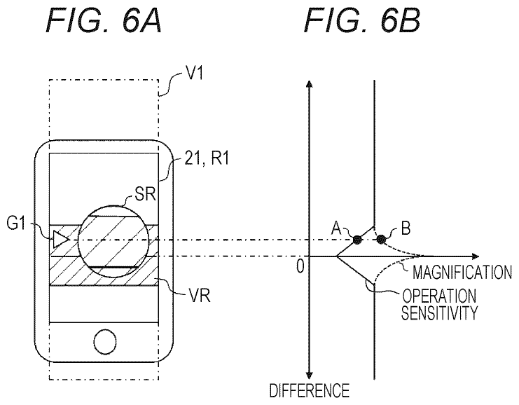

The magnification determination processing S36 is processing in which the processor 23 determines the magnification with reference to the operation sensitivity determined in the sensitivity determination processing S33. The magnification determination processing S36 is processing performed simultaneously with the display region update processing S35, and the determined magnification indicates the magnification of the image displayed on the display region R1. The determination of the magnification will be described with reference to FIGS. 6A and 6B. FIGS. 6A and 6B are schematic diagrams illustrating the magnification determination processing S36 executed by the operation terminal 20 illustrated in FIG. 1, FIG. 6A illustrates the display by the operation terminal 20, and FIG. 6B illustrates a correspondence relationship between the operation sensitivity and the magnification.

As illustrated in FIG. 6A, in the magnification determination processing S36, when the difference between the storage state and the current state is less than the threshold value, that is, when the pointer G1 is inside the variable region VR, the processor 23 displays an enlarged region SR in a part of the display region R1. The enlarged region SR is a region in which the virtual screen V1 is enlarged and displayed so as to be superimposed on the front side of the virtual screen V1. The position of the enlarged region SR in the display region R1 is arbitrary, and the enlarged region SR may or may not include the coordinates of the pointer G1.

FIG. 6B illustrates the correspondence relationship between the magnification and the operation sensitivity when the virtual screen V1 is displayed in the enlarged region SR. The correspondence relationship is stored in the memory 22 of the operation terminal 20 in advance. Hereinafter, the correspondence relationship between the magnification and the operation sensitivity may be referred to as a “magnification profile”. The magnification increases or is constant as the operation sensitivity decreases. In a case where the magnification is always constant regardless of the operation sensitivity, when the operation sensitivity changes according to the difference between the storage state and the current state, the ratio of the screen scroll amount to the scroll operation amount also changes. Therefore, followability to the operation of scrolling the image in coordination with the scroll operation amount and the scroll operation direction may degrade, and an intuitive operational feeling may be impaired. However, by further enlarging the image when the operation sensitivity becomes low, the followability to the operation of scrolling the image can be maintained, and therefore the intuitive operational feeling is maintained.

In the present embodiment, the magnification is inversely proportional to the operation sensitivity, and thus the product of the magnification and the operation sensitivity is constant. Here, the apparent screen scroll amount in the enlarged region SR is proportional to the product of the magnification and the screen scroll amount, that is, the product of the magnification, the operation sensitivity, and the scroll operation amount. Therefore, in the present embodiment in which the product of the magnification and the operation sensitivity is constant, the apparent screen scroll amount is always proportional to the scroll operation in the enlarged region SR, and the intuitive operational feeling is more suitably maintained.

In the present invention, the magnification profile is not limited to that illustrated in FIG. 6B, and can be arbitrarily set within a range in which the magnification increases or is constant as the operation sensitivity decreases. For example, the magnification may take two different values, and may be constant at a lower value in a range where the difference is equal to or more than the threshold value, and may be constant at a higher value in a range where the difference is less than the threshold value.

In the magnification determination processing S36, the processor 23 refers to the determined operation sensitivity and the magnification profile, and determines the magnification as an objective variable by introducing the operation sensitivity to the magnification profile as an explanatory variable. As an example, as illustrated in FIGS. 6A and 6B, when the operation sensitivity is the sensitivity corresponding to the point A, the processor 23 determines the magnification to be the magnification corresponding to a point B.

### (Command Transmission Processing S37)

The command transmission processing S37 is processing in which the processor 23 transmits a command signal to the processor 11 of the lens 10. The processor 23 calculates the coordinates of the pointer G1 on the coordinate axis extending in the vertical direction of the virtual screen V1 for the display region RI updated by the display region update processing S35. The processor 23 transmits information indicating the coordinates of the pointer G1 as a command signal to the processor 11 of the lens 10 via the communication interface 12 of the lens 10 and the communication interface 24 of the operation terminal 20.

After transmitting the command signal to the processor 11, the processor 23 returns the control processing S30 to the actuation operation waiting processing S31.

### (Control Processing S10 of Lens 10)

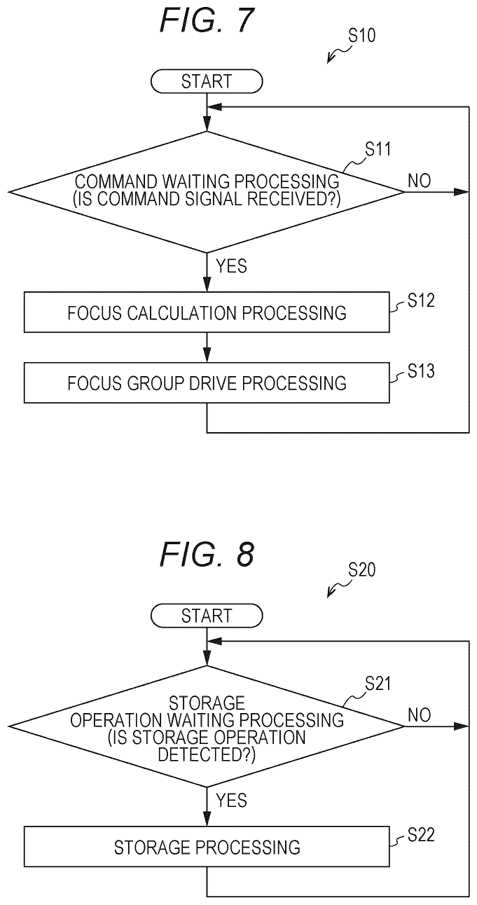

The control processing S10 of the lens 10 will be described with reference to FIG. 7. FIG. 7 is a flowchart illustrating a procedure of the control processing S10 executed by the processor 11 of the lens 10 illustrated in FIG. 1. The control processing S10 is processing of controlling the focus of the lens optical system 30 in coordination with the control processing S30 of the operation terminal 20. As illustrated in FIG. 7, the control processing S10 includes command waiting processing S11, focus calculation processing S12, and focus group drive processing S13. In this embodiment, the above-described processing is mainly performed by the processor 11 of the lens 10.

### (Command Waiting Processing S11)

The command waiting processing S11 is processing in which the processor 11 waits for the command signal transmitted from the processor 23 of the operation terminal 20 in the command transmission processing S37. The processor 11 of the lens 10 loops the command waiting processing S11 while not receiving the command signal (“NO”). When receiving the command signal (“YES”), the processor 11 starts the subsequent focus calculation processing S12.

### (Focus Calculation Processing S12)

The focus calculating processing S12 is processing in which the processor 11 refers to the coordinates of the pointer G1 in the information indicating the coordinates of the pointer G1 on the coordinate axis extending in the vertical direction of the virtual screen V1 as the command signal received in the command waiting processing S11, and calculates the focus as a target for moving the focus group 31 in the subsequent focus group drive processing S13. In the present embodiment, a correspondence relationship between the coordinates of the pointer G1 and the focus is determined by a transform formula defined in the control processing program P10 stored in the memory of the lens 10, and the processor 11 calculates the focus from the coordinates of the pointer G1 based on the transform formula defined in the control processing program P10. In the present embodiment, the correspondence relationship between the coordinates of the pointer G1 and the focus is linear, and thus the amount of change in the focus is directly proportional to the screen scroll amount.

### (Focus Group Drive Processing S13)

The focus group drive processing S13 is processing in which the processor 11 drives the focus group 31 with reference to the focus determined in the focus calculation processing S12. The processor 11 transmits a command signal to a motor associated with the single lens of the focus group 31 to drive the motor, thereby driving the single lens. As a result, the focus calculated in the focus calculation processing S12 is implemented in the focus group 31.

When the driving of the single lens is completed, the processor 11 returns the control processing S10 to the command waiting processing S11.

### (Control Processing S20 of Operation Terminal 20)

The control processing S20 of the operation terminal 20 will be described with reference to FIG. 8. FIG. 8 is a flowchart illustrating a procedure of the processing S20 executed by the processor 23 of the operation terminal 20 illustrated in FIG. 1 to store the storage state to the memory 22. The control processing S20 is processing for storing the focus to the memory 22 as the storage state according to an operation input to the touch display 21. As illustrated in FIG. 8, the control processing S20 includes storage operation waiting processing S21 and storage processing S22. In the present embodiment, the above-described processing is mainly executed by the processor 23 of the operation terminal 20.

### (Storage Operation Waiting Processing S21)

The storage operation waiting processing S21 is processing in which the processor 23 waits for an operation (storage operation) for storing, to the memory 22, the storage state by the user on the touch display 21. While the touch sensor of the touch display 21 does not detect the storage operation by the user (“NO”), the processor 23 loops the storage operation waiting processing S21. When the touch sensor of the touch display 21 receives the storage operation (“YES”), the touch sensor transmits, to the processor 23, a signal notifying detection of the storage operation, and the processor 23 having received the signal starts the subsequent storage processing S22. In the present embodiment, a tap operation on a predetermined graphic user interface (GUI) displayed on the touch display 21 is adopted as the storage operation.

In the present embodiment, the processor 23 executes the storage operation waiting processing S21 simultaneously with the actuation operation waiting processing S31 described above. Therefore, the processor 23 executes the storage processing S22 when receiving the signal notifying the detection of the storage operation (the tap operation on the predetermined GUI), and executes the difference calculation processing S32 when receiving a signal notifying the detection of the actuation operation (the scroll operation).

### (Storage Processing S22)

The storage processing S22 is processing in which the processor 23 stores the focus to the memory 22 as the storage state. By this processing, a state desired by the user is set as the storage state, and can be referred to in the control processing S30. The focus stored as the storage state is determined by an arbitrary method. For example, the stored focus may be the focus when the touch sensor of the touch display 21 detects the storage operation, or may be determined by the processor 23 according to the content of the detected storage operation, for example, the type of the tapped GUI.

The storage processing S22 may be processing in which the processor 23 stores, to the memory 22, at least one of the correspondence relationship between the difference between the storage state and the current state and the operation sensitivity, that is, the sensitivity profile, and the threshold value. By this processing, the sensitivity profile and the threshold value desired by the user are set, and can be referred to in the control processing S30. Which one of the sensitivity profile and the threshold value is stored is determined by an arbitrary method, and may be determined by the processor 23 according to the content of the detected storage operation, for example.

The storage processing S22 may be processing in which the processor 23 stores, to the memory 22, the correspondence relationship between the magnification and the operation sensitivity, that is, the magnification profile. By this processing, the magnification profile desired by the user is set, and can be referred to in the control processing S30.

The storage processing S22 may also serve as (1) the processing in which the processor 23 stores the focus to the memory 22 as the storage state, and (2) the processing in which the processor 23 stores at least one of the sensitivity profile and the threshold value to the memory 22. In this case, which one of the processing of (1) and the processing of (2) is executed is determined by an arbitrary method, and for example, the processor 23 may determine which one of the processing of (1) and the processing of (2) is executed, according to the content of the detected storage operation. The storage state, the sensitivity profile, and the threshold value stored in the memory 22 in the storage processing S22 are referred to in the control processing S30 of the operation terminal 20 for controlling the focus.

After storing the predetermined information to the memory 22 in the storage processing S22, the processor 23 returns the control processing S20 to the storage operation waiting processing S21.

### (Additional Control Processing of Lens System 100)

In the present embodiment, the control processing S100 of the lens system 100 further includes restoration processing S40. The restoration processing S40 is executed by the processor 11 and the processor 23 as processing independent of the above-described control processing S10, S20, and S30 according to an operation input to the touch display 21.

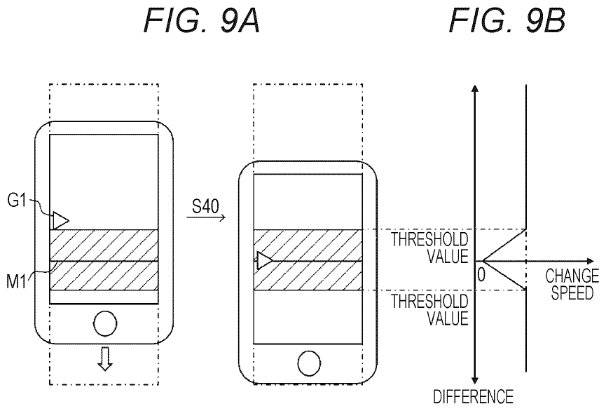

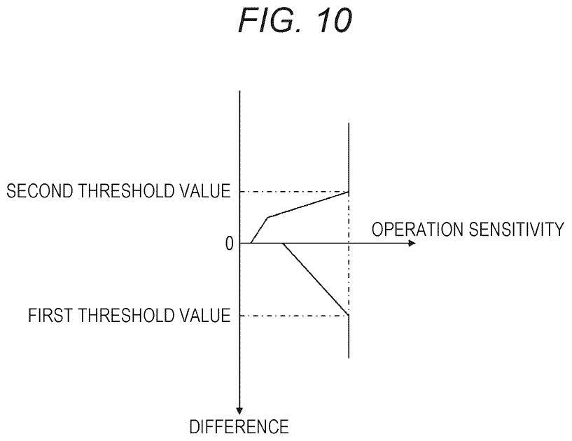

The restoration processing S40 is processing in which the processor 23 of the operation terminal 20 refers to the stored information and updates the graphic displayed in the display region R1 and the processor 11 of the lens 10 controls the lens optical system 30 such that the focus matches the storage state in coordination with the update. The restoration processing S40 will be described with reference to FIGS. 9A and 9B. FIGS. 9A and 9B are schematic diagrams illustrating the restoration processing S40 executed by the processor 23 of the operation terminal 20 and the processor 11 of the lens 10 illustrated in FIG. 1, FIG. 9A illustrates a change in the display by the operation terminal 20 in the restoration processing S40, and FIG. 9B illustrates a correspondence relationship between the difference and the change speed in the restoration processing S40.

When the touch sensor receives a predetermined operation (restoration operation) on the touch display 21 by the user and the processor 23 of the operation terminal 20 receives a signal notifying detection from the touch sensor, the processor 23 starts the restoration processing S40. In the present embodiment, a tap operation on a predetermined graphic user interface (GUI) displayed on the touch display 21 is adopted as the restoration operation. As illustrated in FIG. 9A, the processor 23 scrolls the portion of the virtual screen V1 displayed in the display region R1 such that the pointer G1 indicating the current information matches the marker M1 indicating the stored information, and updates the graphic. During the scrolling, the processor 23 transmits information indicating the coordinates of the pointer G1 on the coordinate axis extending in the vertical direction of the virtual screen V1 to the processor 11 of the lens 10 as a command signal. The processor 11 that has received the command signal controls the focus of the lens optical system 30 similarly to the focus calculation processing S12 and the focus group drive processing S13 described above. Through the above-described processing, the focus changes to match the storage state as a result.

The change speed of the focus is proportional to the speed (scroll speed) at which the processor 23 scrolls the portion displayed in the display region R1. As illustrated in FIG. 9B, the change speed of the focus changes according to the difference between the storage state and the current state during scrolling. In the present embodiment, the change speed is constant when the difference is equal to or greater than the threshold value. When the difference is less than the threshold value, the change speed is lower than when the difference is equal to or greater than the threshold value. When the difference is less than the threshold value, the smaller the difference, the lower the change speed.

According to the restoration processing S40, the focus matches the storage state regardless of the operation amount. Therefore, it is possible to implement the focus desired by the user even under an imaging condition such as a condition for selfie in which it is difficult to keep looking at the touch display 21. In addition, since the change speed of the focus until the focus matches the storage state changes according to the difference between the storage state and the current state during scrolling, the focus can be smoothly controlled.

### [Modification Examples of First Embodiment]

Modification examples of the first embodiment will be described below.

### (Operation Terminal, Operation Member, and Input Operation)

In the present invention, the operation terminal 20 is not limited to a smartphone, and any operation terminal capable of participating in transmission of a command signal to the processor 11 of the lens optical system 30 can be adopted. Examples of the operation terminal 20 include devices having operation members other than the touch display 21, such as a mouse, a keyboard, a ring, a switch, and a pad. Such a device may be formed detachably or non-detachably from the lens 10. As an example, the operation member may be a ring or a switch provided on the lens 10. In a case where a device having an operation member other than the touch display 21 is adopted as the operation terminal 20, any operation that can be input to the device may be adopted as an alternative to the above-described scroll operation. For example, a drag operation or a wheel operation using a mouse, a key operation using a keyboard, a rotation operation using a ring, a pressing operation of a switch, or a stick operation using a pad may be adopted.

In addition, examples of the operation terminal 20 include devices having the touch display 21, such as a rear touch panel of a camera to which the lens 10 can be attached, a tablet personal computer (PC), a gimbal with a touch display, a laptop with a touch display, a personal digital assistant (PDA), a smartwatch, and a touch panel digital signage. In a case where a device having the touch display 21 is adopted as the operation terminal 20, a scroll operation may be adopted as the actuation operation as described above, or another touch operation may be adopted as the actuation operation.

Regarding the actuation operation, what the processor 23 refers to in the screen scroll amount calculation processing S34 is not limited to the operation amount. The processor 23 may refer to the operation speed instead of or in addition to the operation amount. As an example, the processor 23 may execute the screen scroll amount calculation processing S34 such that the screen scroll amount increases as the operation speed increases and that the screen scroll amount decreases as the operation speed decreases, for example. In addition, in a case where a device including the touch display 21 is adopted as the operation terminal 20, a configuration may be adopted in which a flick operation is adopted as the actuation operation, and the operation speed (flick speed) of the flick operation is referenced as an alternative to the operation amount. In this case, after a finger is released from the touch display 21 in the flick operation, the processor 23 refers to the flick speed and reduces the speed of scrolling by inertia while scrolling the screen more greatly as the operation speed is higher. The processor 23 further controls the speed of scrolling such that the smaller the difference between the storage state and the current state, the lower the speed of scrolling. The processor 11 controls the focus in coordination with such scrolling of the screen.

In the lens system 100, the operation member may be provided in the lens 10 including the lens optical system 30. In this case, the processor 11 of the lens 10 may further function as the processor 23 of the operation terminal 20, and the memory of the lens 10 may further serve as the memory 22 of the operation terminal 20. In this case, the processor 11 of the lens 10 may continuously execute processing similar to the control processing S30 and processing similar to the control processing S10 except that the processor 11 does not execute the command transmission processing S37 and the command waiting processing S11.

The lens system 100 may include two or more operation members. When two or more operation members are included in the lens system 100, the actuation operation of the control processing S30 or the storage operation of the control processing S20 may be assigned to each of the two or more operation members. Examples of the two or more operation members include a switch and a ring included in the lens 10. In such a case, the storage operation may be assigned to the switch operation, and the actuation operation may be assigned to the ring operation. Generally, in the ring operation of the lens 10, manually and smoothly reducing the operation speed is a technique that requires skill, and the quality of an image captured is affected by a variation of approximately 1 mm in operation amount. However, in the present invention, since the operation sensitivity with respect to the difference in the specific range is lower than the operation sensitivity with respect to the difference in the other ranges, it is possible to alleviate the effect of shaking in the manual operation. Furthermore, one or more operation members may be provided in each of the separate terminals, that is, the lens 10 and the operation terminal 20.

The lens system 100 may not include the display member. As can be easily understood from the above description regarding the control processing S30, in order for the lens system 100 to control the lens optical system such that the operation sensitivity changes according to the difference between the storage state and the current state, it is sufficient that the lens system 100 refers to the storage state, the current state, and the sensitivity profile. Therefore, it is not essential for the lens system 100 to refer to the information displayed on the display member by the lens system 100, for example, the pointer G1.

Furthermore, in the lens system 100, one terminal may also function as the operation terminal 20 and the lens 10. As an example, in one lens, a lens optical system included in the lens may function as the lens optical system 30, and a focus ring and a switch included in the lens may function as operation members included in the operation terminal 20. As another example, in one smartphone, a lens of a camera included in the smartphone may function as the lens optical system 30, and a touch display included in the smartphone may function as the operation member.

### (Lens and Target to be Controlled)

The lens 10 may be configured such that at least one of arbitrary optical elements is controlled. Examples of the optical elements include a focus group, a zoom group, a diaphragm, and a variable ND filter. Furthermore, in the present invention, the lens 10 may be detachably attached to the camera, or may be integrally attached to the camera and may not be detachable from the camera. Examples of the lens 10 detachably attached to the camera include a zoom lens and a single focus lens. Examples of the camera to which the lens 10 is integrally attached include a camera provided in a smart phone or a tablet PC, a compact digital camera, a video camera, a surveillance camera, a far-infrared camera, and a microscope camera.

The state of the lens optical system 30 to be controlled is not limited to the focus, and any optical element related to the lens optical system 30, for example, a zoom, a diaphragm, or a variable ND filter may be controlled. The state to be controlled may be an element that can be controlled without driving a member physically present in the lens optical system 30, for example, a digital zoom. Which of the states of the lens optical system 30 is to be controlled is determined by the processor 23 of the operation terminal 20 according to a mode selected in advance by the user and input to the operation terminal 20.

### (Stored Information)

In the present embodiment, the number of pieces of the stored information is one, but the present invention is not limited thereto, and the number of pieces of the stored information may be two or more. In a case where the number of pieces of the stored information is two or more, in the difference calculation processing S32, the processor 23 selects stored information having the highest priority in a priority determined based on a predetermined algorithm, and applies the selected stored information to the calculation of the difference from the current information. The predetermined algorithm may be any algorithm, and as an example, an algorithm may be adopted in which the smaller a difference between each piece of the stored information and the current information, the higher the priority.

### (Sensitivity Profile)

In the present embodiment, the sensitivity profile is as illustrated in FIG. 4B, but the present invention is not limited thereto, and any sensitivity profile can be adopted. The threshold value may be set asymmetrically before and after the storage state (MOD side and INF side). In addition, a region where the operation sensitivity is 0 in the sensitivity profile may be present.

An example of the sensitivity profile will be described with reference to FIG. 10. FIG. 10 illustrates a modification example of the correspondence relationship between the difference and the operation sensitivity illustrated in FIG. 4B. In the example illustrated in FIG. 10, the sensitivity profile is asymmetric with respect to the axis of the operation sensitivity, and a first threshold value on the positive side of the difference 0 is larger than a second threshold value on the negative side of the difference 0. In addition, a two-stage transition is present in a region from the difference 0 to the second threshold value, and the operation sensitivity with respect to the difference close to 0 is extremely low. In a case where such a sensitivity profile is adopted, and a scroll operation is continuously input at a constant speed from the positive side to the negative side of the difference 0, even if the focus exceeds the storage state (point of the difference 0), which is a desired focus, the operation sensitivity is extremely low, so that the focus exceeds the desired focus at an extremely low speed. Therefore, the excessive change in the focus is suitably reduced.

In addition, in the control of the state of the lens optical system 30, the processor 23 may select one sensitivity profile from two or more sensitivity profiles and execute the control processing S30. In this case, at least one sensitivity profile out of the two or more sensitivity profiles may satisfy that the operation sensitivity changes according to the difference between the storage state and the current state, and the operation sensitivity may be constant in the remaining sensitivity profiles regardless of the difference. The selection of the sensitivity profile may be executed by the processor 23 according to an operation by the user.

The processor 23 may select the sensitivity profile according to the operation direction of the scroll operation. For example, in a case where the sensitivity profile (first profile) illustrated in FIG. 10 and the sensitivity profile (second profile) obtained by inverting the first profile with respect to the axis of the operation sensitivity are stored in the memory 22, the processor 23 may select the first profile in a case where the operation direction is from the positive side to the negative side of the difference, and select the second profile in a case where the operation direction is the opposite direction. According to this modification example, even if the storage state is exceeded from either the positive side or the negative side of the difference 0, the operation sensitivity immediately after the storage state is exceeded is extremely low, so that the excessive change in the focus is suitably reduced.

In the present embodiment, the threshold value is set using the object distance (meter) between the near end (MOD) and the infinite end (INF) of the focus as a unit, but the present invention is not limited thereto, and the threshold value may be set using an arbitrary unit. As an example, the depth of field may be used as a unit. As a specific example in this case, the processor 23 may calculate the forward and backward depths of field based on the current state regarding the F number, the focal length, the permissible circle of confusion, or the like, and the difference between the current state and the storage state regarding the object distance, and set the forward and backward depths of field as the threshold value such that the difference between the current state and the threshold value becomes a predetermined difference regarding the depths of field.

### [Supplementary Note]

The present invention is not limited to the above-described embodiments, but can be modified in various ways within the scope of the claims. Embodiments obtained by appropriately combining technical means disclosed in different embodiments are also included in the technical scope of the present invention.

### [Summary]

As understood from the above description, the present invention includes the following aspects.

According to a first aspect, a lens system (100) including: a lens optical system (30); at least one operation member (21) that receives at least an actuation operation that is an operation for changing a state of the lens optical system; at least one memory (22); and at least one processor (11, 23), in which the at least one processor controls the lens optical system such that operation sensitivity that is a ratio of an amount of change in the state of the lens optical system to an operation amount of the actuation operation input to the at least one operation member changes according to a difference between a storage state that is a state of the lens optical system and is stored in the at least one memory in advance and a current state that is a current state of the lens optical system.

According to a second aspect, the lens system according to the first aspect, in which the at least one processor controls the lens optical system such that, when the difference between the storage state and the current state is less than a threshold value stored in the at least one memory, the operation sensitivity is lower than an operation sensitivity in a case where the difference is equal to or greater than the threshold value.

According to a third aspect, the lens system according to the second aspect, in which the at least one operation member further receives a storage operation that is an operation for storing, in the at least one memory, at least one of a correspondence relationship between the difference between the storage state and the current state and the operation sensitivity, and the threshold value, and the at least one processor stores, in the at least one memory, at least one of the correspondence relationship between the difference between the storage state and the current state and the operation sensitivity, and the threshold value, according to the storage operation input to the at least one operation member.

According to a fourth aspect, the lens system according to the second aspect, further including at least one display member (21) that displays at least one of the storage state and the threshold value, and the current state, in which the at least one display member receives a scroll operation as the actuation operation for changing the state of the lens optical system.

According to a fifth aspect, the lens system according to any one of the first to fourth aspects, further including at least one display member (21) that displays an image scrolled in coordination with an operation amount and an operation direction input to the at least one operation member, in which the at least one processor controls a magnification of the image such that the magnification becomes higher or constant as the operation sensitivity becomes lower.

According to a sixth aspect, the lens system according to any one of the first to fifth aspects, in which the at least one operation member further receives a restoration operation that is an operation for matching the state of the lens optical system with the storage state, and in response to the restoration operation input to the at least one operation member, the at least one processor controls the lens optical system such that the state of the lens optical system changes so as to match the storage state, and that a speed at which the state of the lens optical system changes is changed according to the difference between the storage state and the current state.

According to a seventh aspect, the lens system according to any one of the first to sixth aspects, in which the at least one operation member further receives a storage operation that is an operation for storing the storage state in the at least one memory, and the at least one processor stores, in the at least one memory, the state of the lens optical system as the storage state according to the storage operation input to the at least one operation member.

According to an eighth aspect, a program for controlling a lens system (100) including a lens optical system (30), at least one operation member (21) that receives at least an actuation operation that is an operation for changing a state of the lens optical system, at least one memory (22), and at least one processor (11, 23), the program including causing the at least one processor to execute processing of controlling the lens optical system such that operation sensitivity that is a ratio of an amount of change in the state of the lens optical system to an operation amount of the actuation operation input to the at least one operation member changes according to a difference between a storage state that is a state of the lens optical system and is stored in the at least one memory in advance and a current state that is a current state of the lens optical system.

What is claimed is:

1. A lens system comprising:
a lens optical system;
at least one operation member that receives at least an actuation operation that is an operation for changing a state of the lens optical system;
at least one memory; and
at least one processor, wherein
the at least one processor controls the lens optical system such that operation sensitivity that is a ratio of an amount of change in the state of the lens optical system to an operation amount of the actuation operation input to the at least one operation member changes according to a difference between a storage state that is a state of the lens optical system and is stored in the at least one memory in advance and a current state that is a current state of the lens optical system.

2. The lens system according to claim 1, wherein
the at least one processor controls the lens optical system such that, when the difference between the storage state and the current state is less than a threshold value stored in the at least one memory, the operation sensitivity is lower an operation sensitivity in a case where the difference is equal to or greater than or the threshold value.

3. The lens system according to claim 2, wherein
the at least one operation member further receives a storage operation that is an operation for storing, in the at least one memory, at least one of a correspondence relationship between the difference between the storage state and the current state and the operation sensitivity, and the threshold value, and
the at least one processor stores, in the at least one memory, at least one of the correspondence relationship between the difference between the storage state and the current state and the operation sensitivity, and the threshold value, according to the storage operation input to the at least one operation member.

4. The lens system according to claim 2, further comprising
at least one display member that displays at least one of the storage state and the threshold value, and the current state, wherein
the at least one display member receives a scroll operation as the actuation operation for changing the state of the lens optical system.

5. The lens system according to claim 1, further comprising
at least one display member that displays an image scrolled in coordination with an operation amount and an operation direction input to the at least one operation member, wherein
the at least one processor controls a magnification of the image such that the magnification becomes higher or constant as the operation sensitivity becomes lower.

6. The lens system according to claim 1, wherein
the at least one operation member further receives a restoration operation that is an operation for matching the state of the lens optical system with the storage state, and
in response to the restoration operation input to the at least one operation member, the at least one processor controls the lens optical system such that
the state of the lens optical system changes so as to match the storage state, and that a speed at which the state of the lens optical system changes is changed according to the difference between the storage state and the current state.

7. The lens system according to claim 1, wherein
the at least one operation member further receives a storage operation that is an operation for storing the storage state in the at least one memory, and
the at least one processor stores, in the at least one memory, the state of the lens optical system as the storage state according to the storage operation input to the at least one operation member.

8. A program for controlling a lens system including a lens optical system, at least one operation member that receives at least an actuation operation that is an operation for changing a state of the lens optical system, at least one memory, and at least one processor, the program causing
the at least one processor to execute processing of controlling the lens optical system such that operation sensitivity that is a ratio of an amount of change in the state of the lens optical system to an operation amount of the actuation operation input to the at least one operation member changes according to a difference between a storage state that is a state of the lens optical system and is stored in the at least one memory in advance and a current state that is a current state of the lens optical system.
